(19) United States
(12) Patent Application Publication
(10) Pub. No.: US 2003/0185372 A1
(43) Pub. Date: Oct. 2, 2003

(54) Method for putting through at least one call having a predeterminable priority

(76) Inventor: Volker Henz, Unterschleissheim (DE)

Correspondence Address: McCormick Paulding & Huber, CityPlace II, 185 Asylum Street, Hartford, CT, 06103-4102, US

(21) Appl. No.: 10/333,494

(22) PCT Filed: Jul. 27, 2001
(86) PCT No.: PCT/DE01/02855

(30) Foreign Application Priority Data
Jul. 28, 2000 (DE) 100 36 902.2

(51) Int. Cl. H04M 3/42

(52) U.S. Cl. 379/207.02

(57) ABSTRACT

The invention relates to a method for putting through at least one call having a predeterminable priority (cpr) to at least one subscriber connection (TA1 n) allocated to at least one call distribution system (CDS). The distribution of the at least one call which is to be put through to the group (CDS) is controlled according to the respective priority (cpr) thereof. The inventive method represents a useful extension of the MLPP standard in the direction of the call centre, the triggering of calls being avoided by calls having a higher priority.

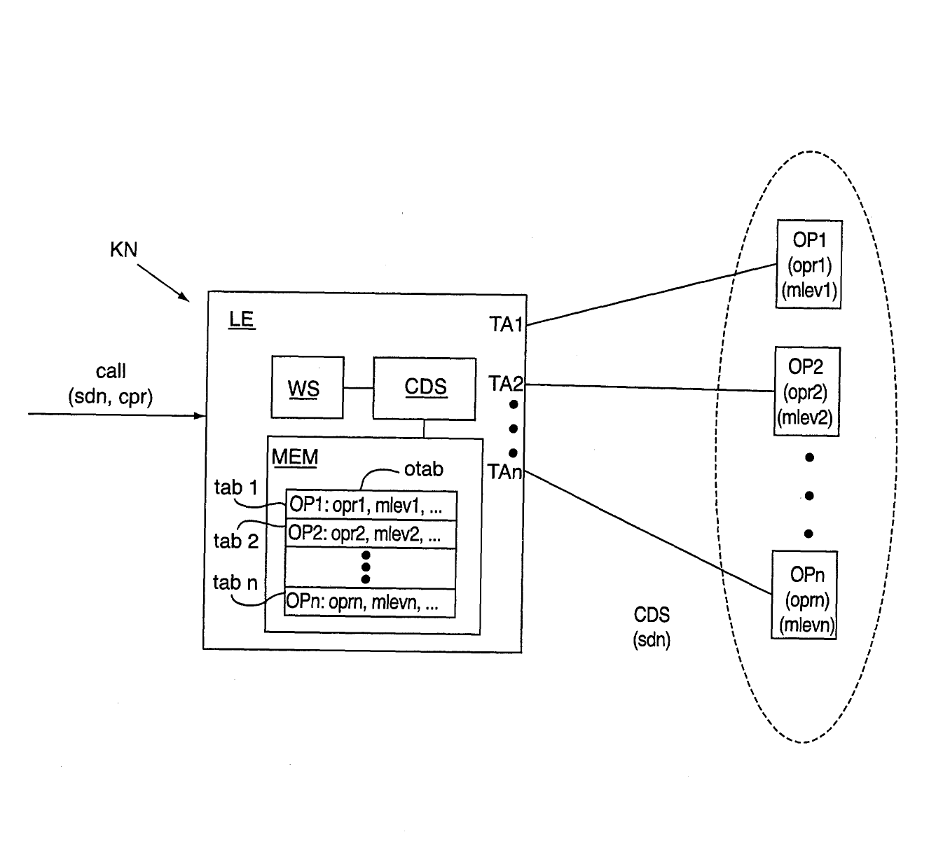

### DESCRIPTION

Method for putting through at least one call having a predeterminable priority.

Using switching systems used in current communication networks, such as, for example, the EWSD switching system by Siemens AG, the call distribution systems or call centers used in these systems provide very efficient solutions which implement a multiplicity of features associated with automatic call distribution on the basis of task groups. These task groups represent, for example, personal activity profiles—also called skills—of operators of the call distribution system and also task distributions which are staggered throughout the day or modified for a short time. Furthermore, these call distribution systems support the inclusion of recorded announcement machines—e.g. for an automatic greeting or for charge announcements or of automatic store-and-forward machines—e.g. for automatically transferring a call after a directory inquiry. Furthermore, external databases can be tied into the call distribution system (CDS) via the support application server (SAS), for instance in order to forward a call to a person regularly dealing with the caller or to display the relevant customer records immediately to the operator at the corresponding communication terminal on the basis of the directory number of the caller.

The workstations for operators or agents, used in call distribution systems, also called operator terminals in the text which follows, can be connected to the switching system via subscriber lines of different designs. For example, the subscriber lines can be designed

as analog subscriber line and/or

as ISDN basic access and/or

as ISDN primary multiplex access and/or

as a subscriber line implementing an xDSL transmission method and/or,

as cordless subscriber line for connecting a cordless communication terminal, and/or

as mobile-radio-compliant subscriber line for connecting a mobile wireless communication terminal.

The subscriber lines allocated to a call distribution system can be arranged in a number of switching systems arranged in the communication network. Furthermore, the subscriber lines can be arranged in different communication networks—e.g. in the landline network and in the mobile radio network.

As long as free operators or agents who can deal with the tasks of a task group are still available for calls arriving at a call distribution system, the incoming calls or tasks are put through to the free operators or agents directly associated with this task group. If no free operators or agents are available for the required task group, the incoming tasks or calls are placed into a queue allocated to the respective task group. The queued calls remain in the respective queue until a suitable operator or agent can process them.

Within current communication networks or telephone networks, signaling for the setting up and clearing down of 64-kbit payload channel connections for controlling ISDN services takes place on the basis of the ITU-T signaling system No.7—also called SS No.7. The ISDN services provided by ISDN-compliant communication networks are subdivided into normal ISDN services and supplementary services. According to ITU-T, the supplementary services are divided into eight groups:

directory-number-related supplementary services,

destination-related supplementary services,

supplementary services for call completion,

supplementary services for the participation of a number of subscribers,

supplementary services for user groups,

supplementary services for the transmission of additional information, and

supplementary services for mobility and modification.

The supplementary service for user groups—also called “community of interests supplementary services” includes all supplementary services which can be jointly used by users (groups). The feature “multi-level precedence and pre-emption service” (MLPP) represents a supplementary service which can be used jointly by users (groups). The multi-level precedence and pre-emption service (MLPP) supplementary service provides the corresponding service users with call processing with a number of priority levels. The MLPP supplementary service is provided to the service user on application and can relate either to the directory number and/or to the service. For example, in an MLPP supplementary service, calls with higher priority (a call with a higher priority than the priority of the call previously received) are diverted at the service user or B party to a predetermined destination—e.g. C party or inquiry station—if the uninterruptible service user is busy or does not answer.

As an alternative, however, a priority call or a call with higher priority can also force an interruption in an active call, also called forced release, in which

each party of the active call is informed about the forced release,

each called interruptible subscriber or B party has the possibility of confirming the forced release, or

in the case of a lack of resources, i.e. in the case of a lack of available payload or B channels or in the case of a lacking number of simultaneously conducted calls—the call with the lowest priority is released.

The multi-level precedence and pre-emption service (MLPP) feature is mainly used in military networks.

The MLPP supplementary service is currently only defined by the ITU-T—ITU-T: I.255.3: Integrated Services Digital Network (ISDN), General Structure and Service Capabilities, Multi-Level Precedence and Pre-emption Service (MLPP), ITU-T, Geneva, September 1990. The standard for the MLPP supplementary service provides that an incoming prioritized call releases a lower prioritized call on the B party side, i.e. the called subscriber or B party must accept the incoming prioritized call; he is not able to save the old call or the previous connection. However, this forced release in the MLPP supplementary service cannot be used, or makes no sense, in the environment of a call center since the call having a particular priority or the call having a predetermined priority is addressed to a group of operators or agents of the respective call center and may have to be inserted into a queue.

The invention is based on the object of improving the treatment or processing of calls having a predetermined priority and having to be put through in the environment of a call distribution system. The object is achieved by a method according to the features of the preamble of patent claim 1 by means of its characterizing features.

In the method according to the invention, at least one call having a predeterminable priority is put through to at least one subscriber line arranged in at least one communication network and associated with at least one group, the at least one group being associated with at least one call distribution system controlling the distribution of the call. The essential aspect of the method according to the invention consists in that the distribution of the at least one call to be put through to the at least one group is additionally controlled in dependence on its respective priority.

The method according to the invention for putting through calls having a predeterminable priority represents an extension of the MLPP standard in the direction of call distribution systems or call centers. The essential advantage of the method according to the invention consists in that, whilst retaining the MLPP signaling, a behavior in the call-distribution-system-controlled putting-through of prioritized calls is defined which provides for a useful application of call prioritization according to the MLPP standard. Using the method according to the invention, a putting-through of prioritized calls is achieved in which a forced release of existing calls is not required.

Further advantageous embodiments of the method according to the invention can be found in further claims.

In the text which follows, the method according to the invention is explained in greater detail by means of a block diagram. The block diagram shows a switching system LE, arranged in a communication network KN, in which a call distribution system CDS is arranged. The call distribution system CDS is associated with a memory device MEM and a queue WS. A certain number of agents or operators or operator terminals OP1 . . . N, associated with the call distribution system CDS, is connected to the call distribution system CDS via a number of subscriber lines TA1 . . . N arranged in the switching system LE. The call distribution system CDS provides, for example, a global information service, e.g. “national information” or “international information”, in which the different information services can be dialed under a particular service directory number sdn. The individual operators OP1 . . . n of the call distribution system CDS are in each case allocated an operator-oriented operator priority opr1 . . . n by means of which the switching and/or operational behavior of the respective operator or operator terminal OP1 . . . n in the case of calls having a particular MLPP priority, or MLPP calls, arriving at the call distribution system or call center CDS, is determined. In the block diagram, a call arriving at the switching system LE and having a predetermined MLPP priority cpr, with a destination directory number sdn specifying the call distribution number CDS as destination, is illustrated by way of example by an arrow call (sdn, cpr).

An operator OP1 . . . n of the call distribution system CDS can simultaneously process one or more calls having different MLPP priorities at a particular time—e.g. setting up a three-party connection or a large conference involving a number of parties. The operator priority opr1 . . . n in each case current at this time is determined by the MLPP priority of the call currently conducted via the operator OP1 . . . n. In the case of a number of simultaneous calls conducted via an operator OP1 . . . n—e.g. during the setting-up of a large conference with twenty parties—the current operator priority opr1 . . . n is determined by the call with the highest MLPP priority currently conducted or processed by the operator OP1 . . . n, using only MLPP priorities of active calls—i.e. parked calls, for example, are not assessed for determining the current operator priority.

According to the MLPP standard, the MLPP priority allocated to a call can have a value between 0 and 4, the value 0 representing the highest priority and the value 4 representing the lowest priority.

In the memory device MEM associated with the call distribution system CDS, a table otab having a number of table entries tab1 . . . n is arranged, in each case operator-oriented information being stored in each table entry tab1 . . . n. Thus, among other things, the current operator-oriented operator priorities opr1 . . . n and other information representing the state of the individual operators OP1 . . . n are stored in the respective table entries tab1 . . . n, not shown.

For the further exemplary embodiment, it is assumed that the call arriving at the call distribution system CDR is to be forwarded to a suitable agent or operator OP1 . . . n of the call center CDS. In the text which follows, the method according to the invention for putting through a call (call) having a predetermined priority cpr is explained in greater detail.

According to a first exemplary scenario, it is assumed that all operators OP1 . . . n associated with the call distribution system CDS are busy. In this case, the call arriving at the call distribution system CDS is put through to the agent OP1 . . . n having the currently lowest operator priority opr1 . . . n, i.e. the call is put through to the agent currently processing a call having the lowest MLPP priority. During this process, an implied “call waiting” is carried out, i.e. the call distribution system CDS puts the incoming call through to the respective agent OP1 . . . n without payload channel or B channel. The incoming call is indicated to the selected agent at his operator terminal OP1 . . . n, for example by means of suitable information on an operator interface associated with the respective workstation of the agent OP1 . . . n, not shown, with an unambiguous indication of the higher prioritization of the incoming call. The indication indicating the highest prioritization provides the agent OP1 . . . n with a number of possibilities of processing the incoming call. For example, the call or calls currently routed or switched via the selected agent OP1 . . . n can be released or parked or held by the agent in order to accept the incoming call with higher priority.

The calls (call) arriving at the call distribution system CDS are put through, inter alia, in dependence on the current operator priorities opr1 . . . n stored in the table tab. The table entries tab1 . . . n are advantageously searched in ascending order of the stored operator priorities opr1 . . . n. An incoming call with the priority cpr is transferred to the agent OPR1 . . . n processing a call having, for example, the lowest MLPP priority.

As an alternative, a table entry tab1 . . . n is determined to which the following relation applies:

opr1 . . . n<cpr,

i.e. the next-best operator OP1 . . . n is determined who has a lower operator priority opr1 . . . n than the priority cpr of the call to be put through.

If the call distribution system CDS cannot find a free, i.e. suitable, agent or operator OP1 . . . N having a current operator priority opr1 . . . n which is lower than the MLPP priority cpr of the incoming call, the incoming call is inserted into the queue WS of the call distribution system CDS in dependence on the MLPP priority cpr. Advantageously, the queuing of the calls to be put through takes into account the respective MLPP priorities, i.e. the higher the MLPP priority cpr of the incoming call, the lower the waiting time of the call in the queue WS.

To keep the operator priorities opr1 . . . n stored in the respective table entries tab1 . . . n updated, the individual operators OP1 . . . n transmit the in each case current operator priorities opr1 . . . n or the in each case current status of the operator OP1 . . . n to the call distribution system CDS during certain switching and/or operational actions, and store these correspondingly in the memory device MEM. Examples of relevant actions are:

acceptance of an incoming call:

the MLPP priority of the accepted call is transmitted to the call distribution system CDS,

outgoing, second call:

the highest MLPP priority of the calls currently conducted is transmitted to the call distribution system CDS,

the call is parked:

the agent is free, no MLPP priority is stored in the memory device MEM,

the call is deparked:

the highest MLPP priority is transmitted to the switching system LE (in the case which two or more calls are conducted via one operator OP1 . . . N).

To ensure optimum operation of the call distribution system CDS, the respective agent OP1 . . . n of the call distribution system CDS must be assigned the authority to process incoming calls with the highest MLPP priority cpr.

In the calls accepted by the operators OP1 . . . n and to be forwarded, the individual operators OP1 . . . n of the call distribution system CDS can set up additional or further calls into the communication network KN, and the calls additionally set up can also be assigned in each case a particular MLPP priority by the operators OP1 . . . n. In this context, the MLPP priorities assigned to the calls additionally set up can also have higher or lower values than the value of the MLPP priority cpr of the call (call) accepted and to be forwarded. As an alternative, the call additionally set up can be automatically allocated an MLPP priority, the value of the MLPP priority cpr of the incoming call (call) also being automatically allocated with the call additionally set up.

After the additional call has been successfully set up, the call to be forwarded is forwarded to the destination via the additional call. This is achieved by combining the call to be forwarded with the additional call. The switching process is also called “call transfer”. If, during the call transfer, two calls, i.e. incoming and outgoing call having different MLPP priorities, are combined, the call combined or put through is automatically allocated the value of the higher MLPP priority.

To ensure consistency between the call arriving, or the incoming and the outgoing call, conducted via an operator OP1 . . . n, the network indicator and the network domain both of the incoming call and of the outgoing call must have the same values. To ensure this, the network indicator and the network domain of the incoming call is also used for setting up the outgoing call for setting up the second and every further call—for example for setting up telephone conferences.

If an agent OP1 . . . n sets up an outgoing call with a particular MLPP priority without there being an incoming call, an MLPP priority mlev1 . . . n defined as operator-specific default value is advantageously used for the outgoing call. The operator-specific MLPP priority mlev1 . . . n defined by default for each operator is advantageously stored in the respective records tab1 . . . n of the memory device MEM associated with the call distribution system CDS.

According to a further exemplary scenario it will be assumed that, in the case of a call arriving at the call distribution system CDS, suitable agents OP1 . . . n of the call distribution system CDS are free. In this case, the incoming call is delivered to a free agent OP1 . . . n and, at the same time, information about the MLPP priority cpr of the incoming call is displayed to this agent.

Using the method according to the invention, calls having a predetermined MLPP priority cpr can be processed in the environment of a call distribution system or call center CDS. The method according to the invention thus represents a meaningful extension of the MLPP standard in the direction of a call distribution system or call center. The method according to the invention prevents other calls without or with a lower MLPP priority being lost by a network operator due to the putting through of calls having a particular MLPP priority. Using the method according to the invention, the quality of services provided by a call distribution system CDS can continue to be guaranteed. Using the method according to the invention, an operational and switching-related behavior which provides for meaningful application of call prioritization is defined in the putting-through of calls having a predetermined MLPP priority, whilst retaining the MLPP signaling. In particular, the releasing of existing calls by calls with high priority is prevented in the environment of call centers, the prioritized calls being put through, nevertheless.

1. A method for putting through at least one call (call) having a predeterminable priority (cpr) to at least one subscriber line (ta1 . . . n) arranged in at least one communication network (KN) and associated with at least one group (CDS), the at least one group (CDS) being associated with at least one call distribution system controlling the distribution of the call, characterized in that the distribution of the at least one call (call) to be put through to the at least one group (CDS) is controlled in dependence on its respective priority (cpr).

2. The method as claimed in claim 1, characterized in that the subscriber lines (ta1 . . . n) are in each case connected to at least one operator terminal (OP1 . . . n) representing a workstation for operators or agents of the call distribution system.

3. The method as claimed in claim 2, characterized
in that at least some of the operator terminals (OP1 . . . n) conduct at least one call from and/or into the communication network (KN),
in that the call distribution system selects at least one free operator (OP1 . . . n) and puts through the at least one call (call) to be put through to the at least one selected operator (OP1 . . . n), and
in that information representing the priority (cpr) of the call (call) is transmitted to the at least one operator terminal (OP1 . . . n).

4. The method as claimed in claim 2 or 3, characterized
in that operator-oriented priorities (opr1 . . . n) of the respective operators or operator terminals (OP1 . . . n) of the at least one group (CDS) are determined, the operator-oriented priority (opr1 . . . n) of an operator (OP1 . . . n) being determined
by the priority of the call conducted by an operator (OP1 . . . n), or
in the case of a number of calls simultaneously conducted by an operator (OP1 . . . n), by the current call having the highest priority,
in that, in the case where all operators (OP1 . . . n) of the at least one group (CDS) are busy, the call distribution system determines and selects at least one operator or operator operator-oriented priority (opr1 . . . n) than the priority (cpr) of the call (call) to be put through, and
in that information indicating the higher priority of the call (call) to be put through is transmitted to the at least one selected operator (OP1 . . . n).

5. The method as claimed in claim 4, characterized
in that the higher prioritization of the call to be put through is indicated to the at least one selected operator (OP1 . . . n),
in that at least one of the at least one call conducted by the selected operator (OP1 . . . n) and having a lower priority than the call (call) to be put through is released or parked or held, and
in that the at least one call (call) to be put through is put through to the selected operator (OP1 . . . n).

6. The method as claimed in claim 4 or 5, characterized
in that at least one queue (WS) for the call (call) to be put through is allocated to the at least one group (CDS),
in that, if an operator (OP1 . . . n) currently having a lower operator-oriented priority (opr1 . . . n) than the priority (cpr) of the call (call) to be put through is not determined, the call (call) to be put through is held in the at least one queue (WS).

7. The method as claimed in claim 6, characterized in that the call (call) to be put through is inserted in the at least one queue (WS) in dependence on its priority (cpr).

8. The method as claimed in one of the preceding claims, characterized in that
during the forwarding of the at least one call (call) put through to the selected operator (OP1 . . . n) by the selected operator (OP1 . . . n), at least one further call having a further allocatable priority is set up to the at least one destination arranged in the communication network (KN), and
in that the call (call) to be forwarded is put through to the destination via the at least one further call.

9. The method as claimed in claim 8, characterized in that, during the forwarding, the priority (cpr) of the at least one call (call) put through to the selected operator (OP1 . . . n) is allocated to the at least one further call by presetting.

10. The method as claimed in claim 8 or 9, characterized in that, for the call put through to the destination via the further call, the maximum value of the priority of the call to be forwarded and the further priority of the at least one further call is allocated.

11. The method as claimed in one of claims 4 to 10, characterized in that the operators (OP1 . . . n) determine and centrally store the current operator-oriented priorities (opr1 . . . n) or the current priorities of the calls conducted by the individual operators (OP1 . . . n) in the communication network (KN)
at predeterminable time intervals and/or
during the performance of predeterminable operational and/or switching actions.

12. The method as claimed in one of claims 2 to 11, characterized in that
in each case an operator-specific priority (mlev1 . . . n) is allocated by predetermination to the operators (OP1 . . . n),
in that the corresponding operator-specific priority (mlev1 . . . n) is allocated to a further call set up into the communication network (KN) by an operator (OP1 . . . n).

13. The method as claimed in one of the preceding claims, characterized in that the priorities which can be allocated to the calls (call) and to the further calls and to the operators or operator terminals (OP1 . . . n) are designed in accordance with the ISDN-compliant supplementary service “multi-level precedence and pre-emption service” (MLPP).
